(19) United States
(12) Patent Application Publication
(10) Pub. No.: US 2006/0181983 A1
(43) Pub. Date: Aug. 17, 2006

(54) Optimum power control for multilayer optical disc

(75) Inventors: Hubert Ceclle Francols Martens, Eindhoven (NL); Wilheimus Robert Koppers, Eindhoven (NL); Jakob Gerrit Nijbore, Eindhoven (NL); Ronald Joseph Antonius Van Den Oetelaar, Eindhoven (NL); Pierre Hermanus Woerlee, Einhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/549,640

(22) PCT Filed: Mar. 11, 2004
(86) PCT No.: PCT/IB04/50226

§ 371 Date: Sep. 20, 2005

(30) Foreign Application Priority Data
Mar. 24, 2003 (EP) 03100757.8

(51) Int. Cl. G11B 7/00

(52) U.S. Cl. 369/47.5; 369/59.11; 369/116

(57) ABSTRACT

A method of recording information on a multilayer record carrier includes a power control procedure for setting the writing power of a recording beam for a lower recording layer (41). First an upper area in an upper recording layer (40), i.e. the recording layer closest to the laser entry side of the record carrier, is recorded. Secondly a power control zone (60) is located on the lower recording layer such that the upper area substantially covers a radial position range on the upper recording layer corresponding to a radial position range of the power control zone on the lower recording layer (41). Finally an optimum power control (OPC) procedure for setting the writing power of the beam for the lower recording layer is performed by writing a test pattern of marks in the power control zone.

The invention relates to a record carrier of a writable type for recording information by writing marks in a track.

The invention further relates to a device for scanning the record carrier and a method for providing information via the record carrier.

A multilayer optical recording medium is known from US Patent Application US2002/0150005. The record carrier comprises a guide groove, usually called pregroove, for indicating the position of tracks in which the information is to be represented in a predefined manner by recording optically readable marks. The pregroove is meandering by a periodic excursion of the track in a transverse direction (further denoted as wobble). The wobble may be varied in period according to additional information such as addresses. A scanning device is provided with a head for generating a beam of radiation for scanning the track. The marks are detected during said scanning by variations of the reflectivity of the scanned surface. The variations in intensity of the reflected radiation are detected by a main detector system. Furthermore the scanning device has auxiliary detectors for generating tracking servo signals based on the pregroove for detecting a spatial deviation of the head with respect to the track. The tracking servo signals are used to control actuators to position the head opposite the track. The variations in period of the wobble are detected for retrieving the auxiliary information, e.g. address information. Test patterns may be pre-recorded on several layers to optimize focusing for each layer. However recording power cannot be easily optimized for each recording layer.

Therefore it is an object of the invention to provide a method for recording information on a record carrier, a recording device and record carrier that allow reliable optimum power control.

According to a first aspect of the invention the object is achieved with a method of recording information on a record carrier of a writable type by writing marks in a track on a recording layer via a beam of radiation entering through an entrance face of the record carrier, the record carrier comprising a first recording layer and a second recording layer, the first recording layer being present at a position closer to the entrance face than the second recording layer, the method comprising a power control step for setting the writing power of the beam for the second recording layer which power control step comprises writing a test pattern of marks in a power control zone located on the second recording layer, and a upper layer recording step preceding the power control step, the upper layer recording step comprising writing marks in an upper area of the first recording layer, the upper area substantially covering a radial position range on the first recording layer corresponding to a radial position range of the power control zone on the second recording layer.

According to a second aspect of the invention the object is achieved with a device as defined in claim 7.

According to a third aspect of the invention the object is achieved with a record carrier as defined in claim 10.

The effect of the measures is that the power control zone for the second recording layer is located at a radial position for which the first recording layer has a defined transmission property, i.e. data is written on the radial area above the power control zone. It is noted that the step called ‘upper layer recording step for recording an upper area’ relates to recording of the layer closest to the entrance face of the laser, which may be above or below the actual record carrier. The position of the power control zone on the second recording layer can be retrieved from the record carrier. This has the advantage that an optimum writing power is reliably determined for the second recording layer.

The invention is also based on the following recognition. The inventors have seen that the optimum power for writing marks on a recording layer that is not the first recording layer closest to the laser is affected by the transmission of the closer layers. Also is has been noted that due to the organization of data the order of writing the recording layers is not random, but usually progresses from the closest layers to layers farther away from the laser. Hence the writing power for the farther layers is best optimized via recorded closer layers, which is accomplished by first recording on the closer layer (or layers) at least the radial area corresponding to the power control zone of a layer farther away before performing the optimizing of the power on that farther away layer.

In an embodiment of the method, wherein on the record carrier the track on the first recording layer extends spirally in a first direction and the track on the second recording layer extends spirally in a second direction opposite to the first direction for constituting a two part recording area logically separated by an intermediate zone that physically is constituted by a first intermediate part located at the end of the first recording layer and a second intermediate part located at the start of the second recording layer, the recording area being preceded by a lead-in zone located at the start of the first recording layer and being followed by lead-out zone located at the end of the second recording layer, the upper layer recording step comprises writing marks in the upper area in an outward direction from an inner radial position to an outer radial position, and the power control step comprises writing the test pattern of marks in the power control zone in an inward direction from the outer radial position to the inner radial position. The record carrier is called an opposite track path (OTP) type. This has the advantage that on the OTP type record carrier the radial area on the closer layer corresponds to the power control zone in the farther away layer.

In an embodiment of the method the upper layer recording step comprises writing marks constituting the lead-in zone. This has the advantage that the lead in zone has to be recorded on the first recording layer to be compliant to standardized recording formats. In a further embodiment the upper layer recording step comprises writing marks constituting the first intermediate part. This has the advantage that a power control zone is available near the outer perimeter of the record carrier. It is noted that the optimum writing power value may slightly differ from inner to outer radial recording positions.

Further preferred embodiments of the device according to the invention are given in the further claims.

These and other aspects of the invention will be apparent from and elucidated further with reference to the embodiments described by way of example in the following description and with reference to the accompanying drawings, in which

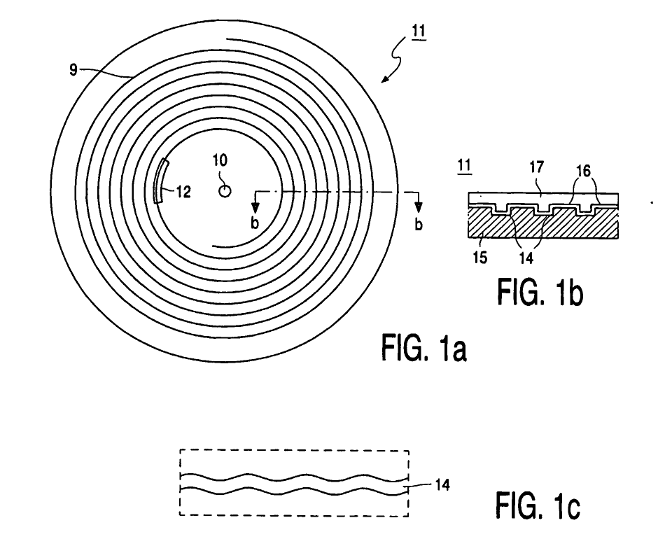

FIG. 1a shows a disc-shaped record carrier (top view),

FIG. 1b shows a cross-section taken of the record carrier,

FIG. 1c shows an example of a wobble of the track,

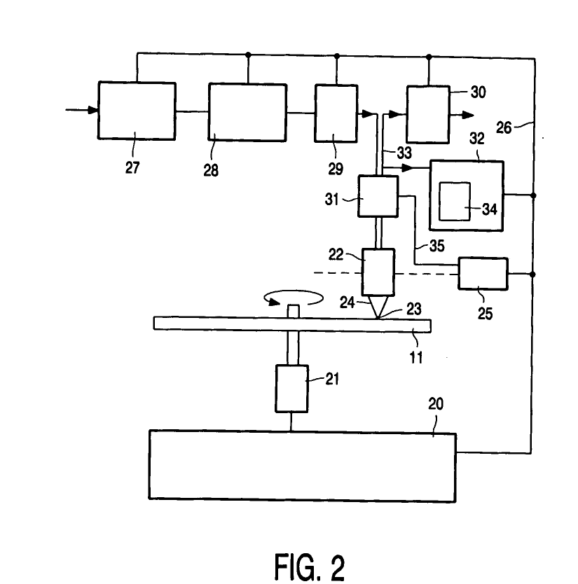

FIG. 2 shows a recording device for performing optimum power control for different layers of a record carrier,

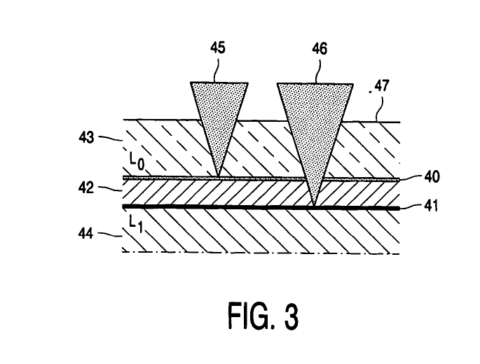

FIG. 3 shows a multilayer optical disc,

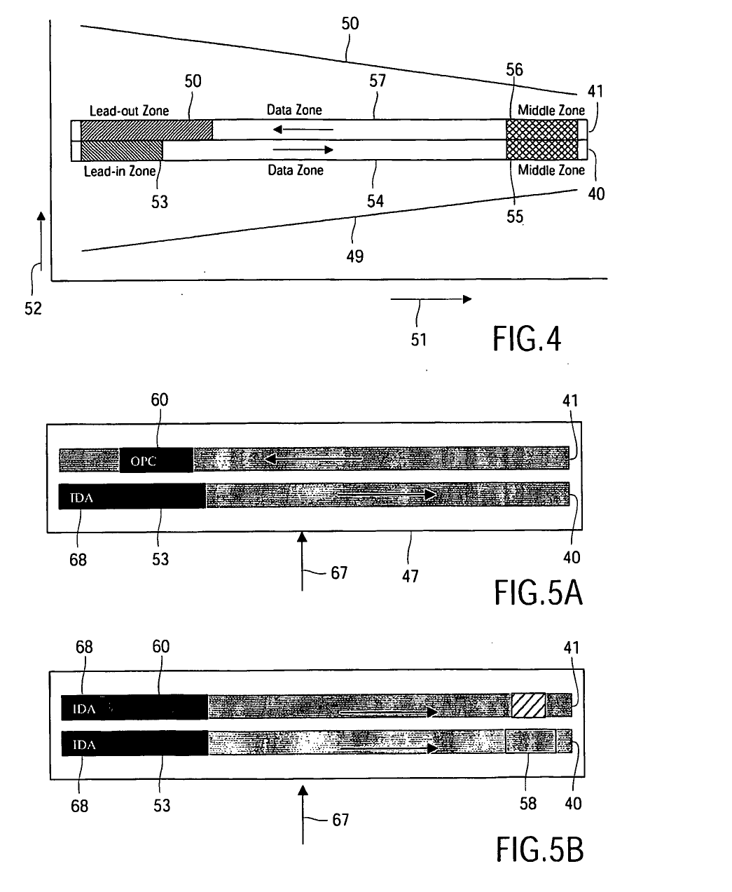

FIG. 4 shows schematically an opposite track path record carrier,

FIG. 5a shows a power control zone for OPC on layer L1 of a dual layer OTP disc,

FIG. 5b shows a power control zone for OPC on layer L1 of a dual layer PTP disc,

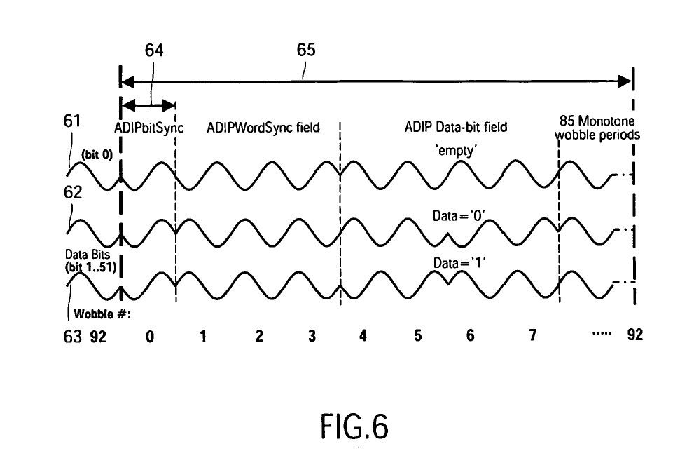

FIG. 6 shows ADIP information in wobble modulation, and

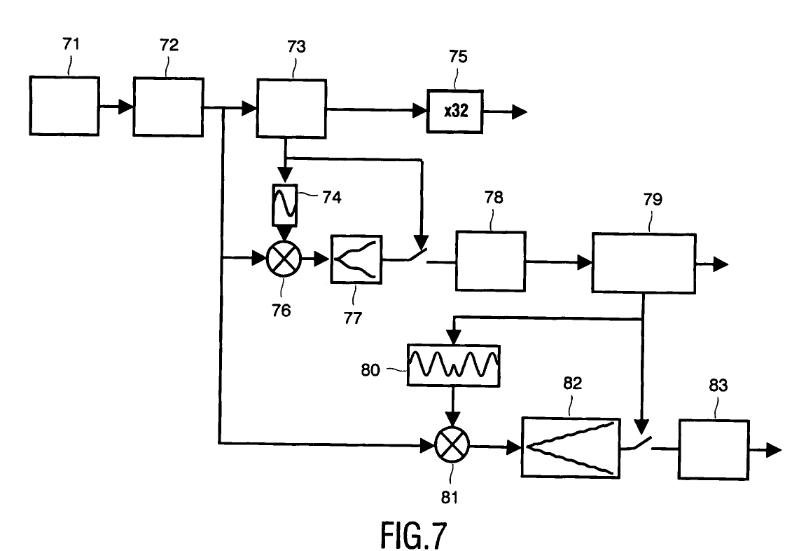

FIG. 7 shows a wobble demodulation unit.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CDR and CD-RW, and the DVD+RW. The track 9 on the recordable type of record carrier is indicated by a pre-track structure provided during manufacture of the blank record carrier, for example a pregroove. Recorded information is represented on the information layer by optically detectable marks recorded along the track. The marks are constituted by variations of a first physical parameter and thereby have different optical properties than their surroundings. The marks are detectable by variations in the reflected beam, e.g. variations in reflection.

FIG. 1b is a cross-section taken along the line b-b of the record carrier 11 of the recordable type, in which a transparent substrate 15 is provided with a recording layer 16 and a protective layer 17. The pre-track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A pre-track structure may also be formed by regularly spread sub-tracks or pre-pits which periodically cause servo signals to occur. The record carrier may be intended to carry real-time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in FIG. 1c in a writable CD system comprising disc information encoded in such a manner can be found in U.S. Pat. No. 4,901,300 (PHN 12.398) and U.S. Pat. No. 5,187,699 (PHQ 88.002).

During readout by scanning the wobble modulation is detectable via a second type of variations of the radiation, such as variation of intensity in the cross section of the reflected beam detectable by detector segments or additional detectors for generating tracking servo signals. Detecting the wobble for a tracking servo system is well known from the above mentioned CD-R and CD-RW system. The wobble modulation is used to encode physical addresses, for example as in the DVD+RW system shown in FIG. 6, while wobble demodulation is shown in FIG. 7.

User data can be recorded on the record carrier by marks having discrete lengths in unit called channel bits, for example according to the CD or DVD channel coding scheme. The marks are having lengths corresponding to an integer number of channel bit lengths T. The shortest marks that are used have a length of a predefined minimum number d of channel bit lengths T for being detectable via the scanning spot on the track that has an effective diameter, usually being roughly equal to the length of the shortest mark.

According to the invention the record carrier is a multilayer record carrier having a modulation of the pre-track structure for encoding power control information indicating the location of a power control zone on a lower recording layer as is schematically indicated by area 12 in FIG. 1a. FIG. 6 gives an embodiment for encoding control information in ADIP. Alternatively the power control information is encoded in pre-pits like in DVD-RW or in a pre-embossed data area using pits and land like in a read-only disc.

It is noted that ‘upper’ (and ‘lower’) indicates the layer closest to (and a layer farther away from) the entrance face of the laser, which in practice may be the top or bottom the record carrier depending on the location of the laser. The power control zone is for performing an optimum power control procedure (OPC) for setting the writing power of the radiation beam for the second recording layer. The power control procedure first starts with writing marks in an upper area of the first recording layer. The upper area covers a radial position range on the upper recording layer corresponding to a radial position range of the power control zone on the lower recording layer. After completing writing the upper area a test pattern of marks is written in the power control zone, for example using different power settings, to determine the optimum writing power. In general such power setting procedures are well known from single layer optical disc recorders, like CDR or DVD+RW. It is to be noted that in practical circumstances the power control zone will be a multitude of windings of the track, i.e. the area being an annular shaped area from a starting to an ending radial position.

FIG. 2 shows a recording device for performing optimum power control for different layers of a record carrier. The device is provided with means for scanning a track on a record carrier 11 which means include a drive unit 21 for rotating the record carrier 11, a head 22, a servo unit 25 for positioning the head 22 opposite the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The error signals 35 are also coupled to a pre-track demodulation unit 32 for retrieving the physical addresses and other control information from the pre-track modulation such as wobble modulation or pre-pits. A detailed embodiment of wobble modulation detection is given in FIG. 6. The main scanning signal 33 is processed by read processing unit 30 of a usual type including a demodulator, deformatter and output unit to retrieve the information.

The device is provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

Writing and reading of information for recording on optical disks and formatting, error correcting and channel coding rules are well-known in the art, e.g. from the CD or DVD system. In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits. According to the invention the control unit performs the function of the optimum power control procedure as described below. In an embodiment the control unit performs the retrieving the power control information from the pregroove via the wobble demodulation unit 32.

FIG. 3 shows a multilayer optical disc. LO is a first recording layer 40 and L1 is a second recording layer 41. A first transparent layer 43 covers the first recording layer, a spacer layer 42 separates both recording layers 40,41 and a substrate layer 44 is shown below the second recording layer 41. The first recording layer 40 is located at a position closer to an entrance face 47 of the record carrier than the second recording layer 41. A laser beam is shown in a first state 45 focused on the L0 layer and the laser beam is shown in a second state 46 focused at the L1 layer. In an embodiment at least one of the recording layers has a pre-track modulation that encodes the power control information that indicates the location of the power control zone, for example the pre-track modulation of the ADIP as shown in FIG. 6.

Multilayer discs are already available as read-only pre-recorded discs, such as DVD-ROM or DVD-Video. A dual layer DVD+R disc has recently been suggested, which disc should preferably be compatible with the dual layer DVD-ROM standard. The reflection levels of both layers are >18%. The L0 layer has a transmission around 50-70%. A spacer layer separates the layers with a typical thickness between 30 and 60 μm. The L1 layer has a high reflection and needs to be very sensitive. Also rewritable dual-layer discs are proposed. The L0 layer has a transmission around 40-60%. The effective reflection of both layers is typically 7% although lower and higher values are possible (3%-18%). Writable and rewritable optical storage media having 3 or more recording layers are considered also.

Due to the required compatibility with existing read-only standardized record carriers, like the DVD-ROM standard, for a DVD-type dual-layer recordable (or rewritable) disc there are two options possible for the layout of the disc. These two options are referred to as ‘parallel track path’ (PTP) and ‘opposite track path’ (OTP), which indicates the direction of the spiral in both layers. In PTP discs there is one information zone per layer (two in total), while in OTP discs there is one information zone extending over the two layers.

FIG. 4 shows schematically an opposite track path record carrier. Horizontally arrow 51 indicates the radial position (increasing outward) and vertically arrow 52 indicates the physical addresses, i.e. sector numbers. Curve 49 indicates the increasing addresses on the L0 layer 40 going outward, while curve 50 indicates the addresses on the L1 layer 41 further increasing going inward. The recording zone have a first data zone 54 on L0 and a second part 57 on L1, interrupted by a middle zone constituted by a first intermediate part 55 at the end of the recording L0 layer 40 and a second intermediate part 56 at the beginning (in track direction) of the L1 recording layer 41. The arrows in the data zones 54,57 indicate the spiral direction. The recording zone is preceded by a lead-in zone 53 at the beginning of the L0 recording layer and concluded by a lead-out zone 58 at the end of the L1 recording layer. It is noted that a multilayer disc having more than two layers may have a third intermediate area at the end of the second recording layer and a fourth intermediate area at the beginning of the third recording layer, and so on. The lead-out zone concludes the last recording layer. According to the invention the power control zone for each layer is located below an upper area of the upper layer. The upper area is first written with data before power control test patterns for the lower layer are written in the power control zones. In the further text “lower layer” of a dual layer disc is used for explaining the invention, which is deemed to include the lower layers in the event of discs having more than two layers.

The problem in dual (multi) layer discs is that the outcome of OPC depends on the presence or absence of data in the other layers. For DVD+R(W)-DL we have the special requirement that the recorded discs should be compatible (as far as possible) with the existing ROM standard. In the record carrier, usually near the inner or outer perimeter of the disc a power control zone is located in the L1 layer in the radial area corresponding to prescribed control data on the L0 recording layer, for example on DVD the lead-in zone, and/or the lead-out zone for PTP or the middle zone for OTP. Hence the power control zone on lower layers is located radially corresponding to an upper zone in the first (L0) recording layer that is to be recorded with prescribed control zones.

FIG. 5a shows a power control zone for OPC on layer L1 of a dual layer OTP disc. The L0 recording layer 40 starts with an IDA area 68 followed by a lead-in zone 53. IDA on L0 stands for inner-drive area; part of this area can be used for OPC on L0. The arrows in the recording layers of the recordable dual-layer disc indicate the direction of the spiral track, in particular an opposite track path (OTP) for a DVD. The arrow 67 indicates the direction of the laser beam into the entrance face 47. On recording layer L1 the power control zone 60 for OPC (Optimum Power Control) is shown. The radial position of the OPC zone is within the radial area covered by the lead-in zone 53.

FIG. 5b shows a power control zone for OPC on layer L1 of a dual layer PTP disc. The L0 recording layer 40 and the L1 recording layer 41 start with an IDA area 68 followed by a lead-in zone 53. The L0 recording layer 40 is concluded with a lead-out zone 58. The arrows in the recording layers of the recordable dual-layer disc indicate the direction of the spiral track, in particular a parallel track path (PTP) for a DVD. The arrow 67 indicates the direction of the laser beam into the entrance face 47. On recording layer L1 the power control zone 60 for OPC (Optimum Power Control) is shown at a radial position within the radial area covered by the lead-out zone 58.

In the DVD ROM standard for dual-layer discs in opposite-track-path (OTP) mode, there is defined one information zone that extends over the two layers. The lead-in zone is located on L0 and ranges from radius 22.6 mm to radius 24.0 mm. In case of parallel-track-path (PTP), there are two information zones, located on the separate layers, and thus each layer has it's own lead-in zone (same radii as OTP L0). In both cases, the lead-in contains control information and should always be present when the discs are to be read by a DVD player. Since the L0 lead-in zone must always be defined, it can be recorded directly after the first OPC procedure on L0 when a blank disc is inserted. In case of OTP discs, the area in L1 below the L0 lead-in does not need to contain user information (either blank or lead-out). Hence it is used for OPC on L1. Taking into account the effect of spacer thickness and radial runout, it means that the power control zone for OPC on L1 can be located from radius 22.7 mm to 23.9 mm on L1.

FIG. 6 shows ADIP information in wobble modulation. The wobble modulation encodes additional information that is called Address In Pregroove (ADIP) in the DVD+RW system. Each ADIP bit 65 is constituted by ADIP bit sync (one wobble period 64 corresponding to 32 channel bits), followed by a ADIP word sync field (3 wobble periods) and the ADIP Data-bit field of 4 wobble periods, followed finally by 85 monotone (i.e. not modulated) wobble periods. The Figure shows a first wobble 61 which is encoded as an ADIP word sync, in which the word sync field has inverted wobbles and the data-bit field has non modulated wobbles. Second wobble 62 encode a data bit value 0 and third wobble 63 encodes a data bit of value 1. Power control information can be encoded via the ADIP data bits.

FIG. 7 shows a wobble demodulation unit. The input unit 71 provides a push-pull signal derived from the head scanning the track. A filter 72 filters the signal by high pass and low pass filters for isolating the wobble frequency and generating a wobble signal. A phase locked loop 73 is locked to the wobble frequency, and generates via a 32× multiplier 75 the synchronous write clock for recording marks in units of channel bits. A synchronous wobble unit 74 provides a wobble clock period to multiplier 76 which also receives the wobble signal. The output of the multiplier 76 is integrated in integrate and dump unit 77, of which the output is samples via a sample switch to a sync threshold detector 78 coupled to a ADIP bit synchronizer that detects the ADIP bit syncs. A second multiplier 81 is provided with a 4 wobble period signal having two inverted and two non inverted wobbles and the wobble signal on a second input for synchronous detection over 4 wobble periods. A second integrate and dump unit 82 integrates output signal of the multiplier 82, while a bit value threshold detector 83 for detecting the values of the encoded bits. Power control information can be retrieved from the ADIP data bits.

Although the invention has been mainly explained by embodiments using optical discs based on change of reflection, the invention is also suitable for other record carriers such as rectangular optical cards, magneto-optical discs or any other type of information storage system that has a pre-applied pattern on a writable record carrier. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Method of recording information on a record carrier of a writable type by writing marks in a track on a recording layer via a beam of radiation entering through an entrance face (47) of the record carrier, the record carrier comprising
a first recording layer (40) and a second recording layer (41), the first recording layer being present at a position closer to the entrance face than the second recording layer, the method comprising
a power control step (OPC) for setting the writing power of the beam for the second recording layer which power control step comprises writing a test pattern of marks in a power control zone located on the second recording layer, and
a upper layer recording step preceding the power control step, the upper layer recording step comprising writing marks in an upper area of the first recording layer, the upper area substantially covering a radial position range on the first recording layer corresponding to a radial position range of the power control zone on the second recording layer.

2. Method as claimed in claim 1, wherein on the record carrier the track on the first recording layer extends spirally in a first direction and the track on the second recording layer extends spirally in a second direction opposite to the first direction for constituting a two part recording area logically separated by an intermediate zone that physically is constituted by a first intermediate part located at the end of the first recording layer and a second intermediate part located at the start of the second recording layer, the recording area being preceded by a lead-in zone located at the start of the first recording layer and being followed by lead-out zone located at the end of the second recording layer, the upper layer recording step comprising writing marks in the upper area in an outward direction from an inner radial position to an outer radial position, and the power control step comprising writing the test pattern of marks in the power control zone in an inward direction from the outer radial position to the inner radial position.

3. Method as claimed in claim 2, wherein the upper layer recording step comprises writing marks constituting the lead-in zone, and/or the upper layer recording step comprises writing marks constituting the first intermediate part

4. Method as claimed in claim 1, wherein the upper layer recording step is performed once for writing marks in an upper area sufficiently large for covering a radial position range on the first recording layer corresponding to a radial position range of a large power control zone on the second recording layer that allows multiple times performing the power control step, in particular during multiple recording sessions.

5. Method as claimed in claim 1, wherein each recording layer on the record carrier comprises a pre-track pattern, and the method comprises the step of retrieving power control information encoded in the pre-track pattern indicating the location of a power control zone on the second recording layer.

6. Method as claimed in claim 1, wherein the record carrier is an optical disc and the upper layer recording step comprises writing marks at the radial position of the upper area on the first recording layer substantially between 22.6 mm and 24.0 mm radially, the power control zone on the second recording layer being located at corresponding radial positions, in particular between 22.7 mm and 23.9 mm radially.

7. Device for recording information on a record carrier of a writable type by writing marks in a track on a recording layer via a beam of radiation entering through an entrance face of the record carrier, the record carrier comprising
a first recording layer (40) and a second recording layer (41), the first recording layer being present at a position closer to the entrance face than the second recording layer, the device comprising
a head (22) for providing the beam, and
a power control unit (20) for setting the writing power of the beam for the second recording layer by
locating a power control zone on the second recording layer, and
writing a test pattern of marks in the power control zone preceded by
writing marks in an upper area of the first recording layer, the upper area substantially being located at a radial position corresponding to the radial position of the power control zone.

8. Device as claimed in claim 7, wherein at least one recording layer on the record carrier comprises a pre-track pattern, and the device comprises a demodulation unit (32) for retrieving power control information from the pre-track pattern, the power control information indicating the location of the power control zone.

9. Device as claimed in claim 7, wherein the power control unit (20) is arranged for writing marks in the upper area by performing an upper power control step for setting the writing power of the beam for the first recording layer which upper power control step comprises writing a test pattern of marks in a power control zone located on the first recording layer.

10. Record carrier of a writable type for recording information by writing marks in a track on a recording layer via a beam of radiation entering through an entrance face (47) of the record carrier, the record carrier comprising
a first recording layer (40) and a second recording layer (41), the first recording layer being present at a position closer to the entrance face than the second recording layer, and
power control information (12) indicating the location of a power control zone (60) on the second recording layer for performing a power control procedure (OPC) for setting the writing power of the radiation beam for the second recording layer which power control procedure comprises
writing marks in an upper area of the first recording layer, the upper area substantially covering a radial position range on the first recording layer corresponding to a radial position range of the power control zone on the second recording layer, and
writing a test pattern of marks in the power control zone.

11. Record carrier as claimed in claim 10, wherein the track on the first recording layer extends spirally in a first direction and the track on the second recording layer extends spirally in a second direction opposite to the first direction for constituting a two part recording area (54,47) logically separated by an intermediate zone that physically is constituted by a first intermediate part (55) located at the end of the first recording layer and a second intermediate part (56) located at the start of the second recording layer, the recording area being preceded by a lead-in zone (53) located at the start of the first recording layer and being followed by lead-out zone (58) located at the end of the second recording layer.

12. Record carrier as claimed in claim 10, wherein at least one recording layer comprises a pre-track pattern (14), the power control information being encoded in the pre-track pattern.

13. Record carrier as claimed in claim 12, wherein the pre-track pattern comprises a pregroove that exhibits a wobble constituted by displacements of the pregroove in a direction transverse to the longitudinal direction of the track, the wobble exhibiting a wobble modulation for representing the power control information.
